(19) United States
(12) Patent Application Publication
(10) Pub. No.: US 2013/0281656 A1
(43) Pub. Date: Oct. 24, 2013

(54) METHODS FOR LABELING A SUBSTRATE HAVING A PLURALITY OF THIOL GROUPS ATTACHED THERETO

(71) Applicant: University of Georgia Research Foundation, Inc. Boyd Graduate Studies Research Center, (US)

(72) Inventors: VLADIMIR POPIK, WATKINSVILLE, GA (US); SELVANATHAN ARUMUGAM, ATHENS, GA (US)

(73) Assignee: University of Georgia Research Foundation, Inc. Boyd Graduate Studies Research Center, Athens, GA (US)

(21) Appl. No.: 13/863,766

(22) Filed: Apr. 16, 2013

Related U.S. Application Data
(60) Provisional application No. 61/636,796, filed on Apr. 23, 2012.

(51) Int. Cl. C07F 7/02

(52) U.S. Cl. CPC C07F 7/025
USPC 530/300; 548/110; 536/23.1; 540/479; 568/377

(57) ABSTRACT

Methods for derivatizing the surface of a substrate having a plurality of thiol groups thereon are disclosed herein. The method can include reacting the thiol groups with an o-quinone methide, which can optionally be generated by irradiating an o-quinone methide precursor compound. In some embodiments, the method can advantageously be reversible. Exemplary o-quinone methides having a cyclic alkyne attached thereto, and precursor compounds for generating such compounds, are also disclosed herein.

This application claims the benefit of U.S. Provisional Application No. 61/636,796, filed Apr. 23, 2012, which is incorporated herein by reference in its entirety.

### GOVERNMENT FUNDING

The present invention was made with government support under Grant No. CHE 0842590, awarded by the National Science Foundation. The Government has certain rights in this invention.

### BACKGROUND

Connection (or ligation in biochemistry) of two or more substrates or immobilization of various compounds are often achieved with the help of “click chemistry,” which describes a set of bimolecular reactions that are modular, wide in scope, high yielding, create only inoffensive by-products, are stereospecific, simple to perform and that require benign or easily removed solvent. Although meeting all of the above requirements is difficult to achieve, several processes have been identified as coming very close to the ideal “click reaction.” Among them are 1,3 dipolar and Diels-Alder cycloadditions, nucleophilic ring opening, non-aldol carbonyl chemistry, and additions to carbon-carbon multiple bonds. Cu(I) catalyzed versions of the Huisgen acetylene-azide cycloaddition, also known as azide click reaction, became the gold standard of click chemistry and have been applied in fields ranging from material science to chemical biology and drug development. However, the use of cytotoxic Cu (I) catalysts has largely precluded application of this click reaction in living systems. Recently discovered catalyst-free 1,3-dipolar cycloaddition of azides to cyclooctynes and dibenzocyclooctynes offers a bio-compatible version of the azide click reaction.

However, there remains a need for catalyst-free ligation methods for connection or immobilization of various compounds.

### SUMMARY

In one aspect, the present disclosure provides a method for derivatizing the surface of a substrate. In one embodiment, the method includes: generating an o-quinone methide having the formula:

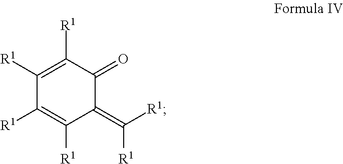

and contacting the o-quinone methide with a substrate having a plurality of thiol groups attached thereto under conditions effective to form a plurality of thioethers (e.g., in an aqueous solution, suspension, or dispersion), wherein: each R¹ is independently H, halogen, or an organic group; and optionally, two or more R¹ groups may be combined to form one or more rings. In certain embodiments, the o-quinone methide is an o-naphthoquinone methide having one of the formulas:

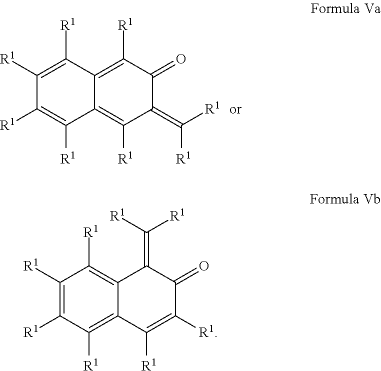

When R¹ represents an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety. In certain embodiments, the substrate includes a planar surface or a bead. In certain embodiments, the substrate can be glass, quartz, silica, a metal, a semi-conductor, a polymer, a membrane, a liposome, a micelle, a macromolecule, a biomaterial (e.g., a virus, a small multicellular organism, DNA, RNA, a peptide, a polypeptide, a protein, a carbohydrate, a lipid, tissue, and combinations thereof), or combinations thereof. As used herein, the term “biomaterial” is meant to include any biological material or material that can be used in a biological method or application. In certain embodiments, the o-quinone methide can include a label that is detectable by method of, for example, fluorescence, phosphorescence, radiation detection, optical methods, electrochemical methods, surface plasmon resonance imaging (SPRi), or combinations thereof. As used herein, a detectable label is meant to include any group or functionality desired that can be detected before and/or after attachment to the surface of a substrate. In certain embodiments, the detectable label can include a probe (e.g., including DNA, a peptide, a polypeptide, a protein, or a combination thereof). Optionally, the method can further include irradiating the derivatized surface of the substrate under conditions effective to reverse at least some of the derivatizaton and provide a substrate having a plurality of thiol groups attached thereto.

In another embodiment, a method for derivatizing the surface of a substrate can include: providing a first precursor compound having the formula:

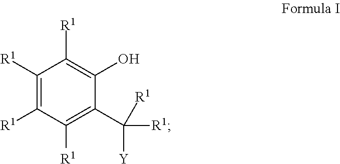

irradiating the first precursor compound under conditions effective to form a first o-quinone methide having the formula:

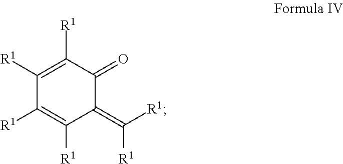

and contacting the first o-quinone methide with a substrate having a plurality of thiol groups attached thereto under conditions effective to form a plurality of thioethers from the reaction of the first o-quinone methide with the plurality of thiols, wherein: each R¹ is independently H, halogen, or an organic group; Y is OR⁵, NR⁵₂, NR⁵₃³⁰ (Z_{1/q})⁻ wherein Z is an anion having a negative charge of q; each R⁵ is independently H or an organic group, optionally, two or more R¹ groups may be combined to form one or more rings; and optionally, two or more R⁵ groups may be combined to form one or more rings. In certain embodiments, the first precursor compound has one of the formulas:

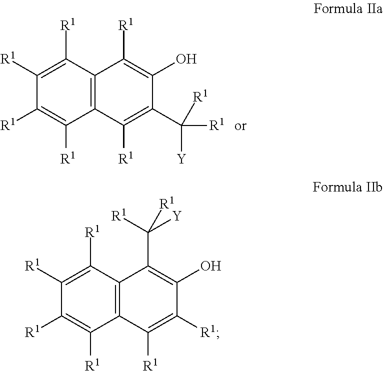

and wherein irradiating the first precursor compound under conditions effective to form the first o-quinone methide forms a first o-naphthoquinone methide having one of the formulas:

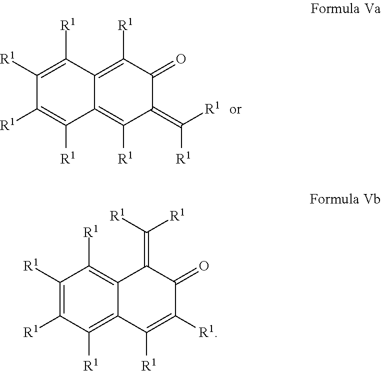

When R¹ and/or R⁵ represent an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety. In certain embodiments, the first precursor compound is irradiated in the presence of the substrate having the plurality of thiol groups attached thereto. In certain embodiments, irradiating the first precursor compound includes pattern-wise irradiating the substrate to provide a pattern-wise derivatized surface of the substrate. Optionally, the method can further include irradiating the derivatized surface of the substrate under conditions effective to reverse at least some of the derivatizaton and provide a substrate having a plurality of thiol groups attached thereto. In another embodiment, the method can further include contacting the derivatized surface of the substrate with a second precursor compound of Formula I, wherein the second precursor compound is different than the first precursor compound; and irradiating the derivatized surface of the substrate under conditions effective to reverse at least some of the derivatizaton and provide a substrate having a plurality of thiol groups attached thereto; to form a second o-quinone methide of Formula IV that is different than the first o-quinone methide of Formula IV; and to form a plurality of thioethers from the reaction of the second o-quinone methide with the plurality of thiols.

In another aspect, the present disclosure provides a substrate having a derivatized surface including a compound having the formula:

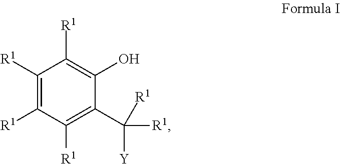

wherein: each R¹ is independently H, halogen, or an organic group; optionally, two or more R¹ groups may be combined to form one or more rings; and Y is a sulfur atom attached to the surface of the substrate. In certain embodiments the substrate has one of the formulas:

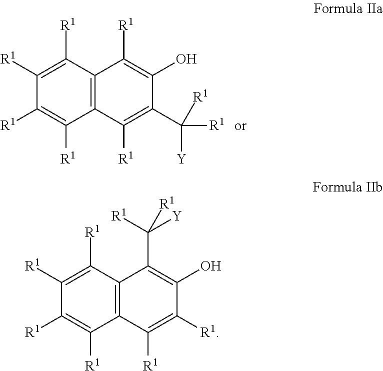

When R¹ represents an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety.

In another aspect, the present disclosure provides a precursor compound having the formula:

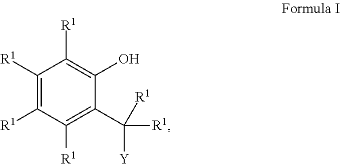

wherein: each R¹ is independently H, halogen, or an organic group; Y is OR⁵, NR⁵₂, NR⁵₃⁺(Z_{1/q})⁻ wherein Z is an anion having a negative charge of q; each R⁵ is independently H or an organic group; optionally, two or more R¹ groups may be combined to form one or more rings; optionally, two or more R⁵ groups may be combined to form one or more rings; and with the proviso that the precursor compound includes a cyclic alkyne (e.g., a dibenzocyclooctyne such as aza-dibenzocyclooctyne) attached thereto. In certain embodiments, the precursor compound has one of the formulas:

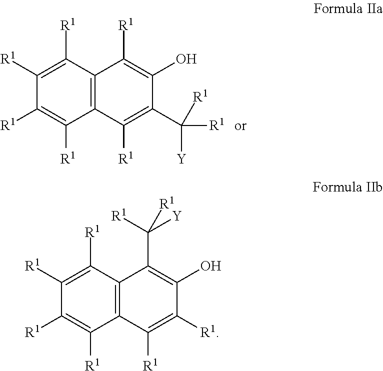

When R¹ and/or R⁵ represent an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety. Such an exemplary precursor compound has the formula

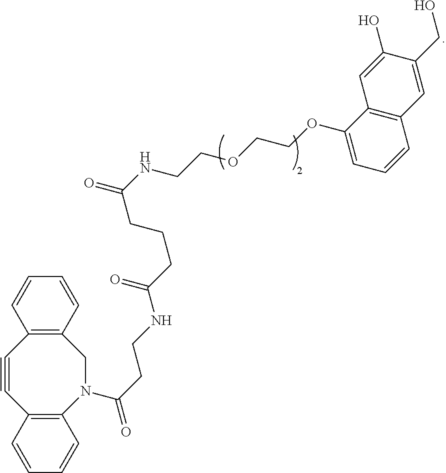

In another aspect, the present disclosure provides an o-quinone methide having the formula:

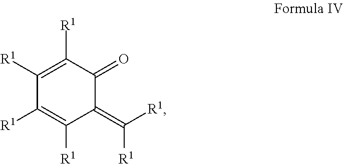

wherein: each R¹ is independently H, halogen, or an organic group; optionally two or more R¹ groups may be combined to form one or more rings; and with the proviso that the o-quinone methide includes a cyclic alkyne (e.g., a dibenzocyclooctyne such as aza-dibenzocyclooctyne) attached thereto. In certain embodiments, the o-quinone methide is an o-naphthoquinone methide of one of the formulas:

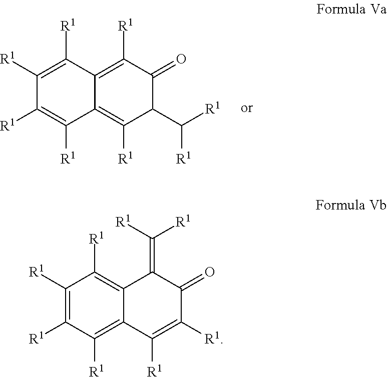

When R¹ represents an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety. Such an exemplary o-quinone methide can be prepared by the photolysis of a precursor compound having the formula

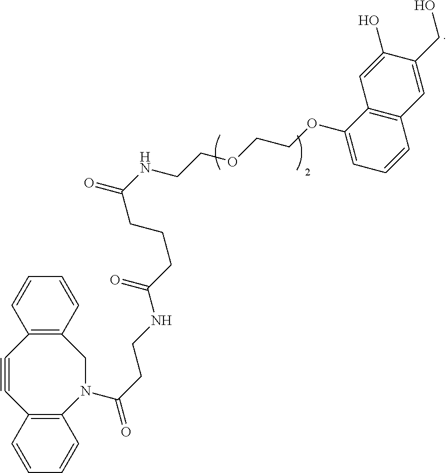

In some embodiments, the methods and compositions described herein can provide thiol-coated surfaces that are easy to manufacture, that are photochemically stable, and that do not require special handling. Many thiol-coated substrates are commercially available. Preparation of o-naphthoquinone methide precursor-tagged (NQMP-tagged) substrates can be a convenient procedure. The o-naphthoquinone methide precursor (NQMP) group can have a long shelf life and excellent stability. In certain embodiments the photo-patterning methods disclosed herein can be “green”: they can use water as a solvent, and solution used for the surface derivatization can be re-used many times, because only reagent “clicked” to mono-layer is consumed. In other certain embodiments, a photoclick reaction between a thiol and an o-naphthoquinone methide (oNQM) can be reversible, which can provide, for example, replacement of immobilized substrates, repair of the coating of the derivatized surfaces, and/or complete removal of the substrate from the surface.

### DEFINITIONS

The terms “comprises” and variations thereof do not have a limiting meaning where these terms appear in the description and claims.

As used herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above brief description of various embodiments of the present invention is not intended to describe each embodiment or every implementation of the present invention. Rather, a more complete understanding of the invention will become apparent and appreciated by reference to the following description and claims in view of the accompanying drawings. Further, it is to be understood that other embodiments may be utilized and structural changes may be made without departing from the scope of the present invention.

### BRIEF DESCRIPTION OF THE DRAWINGS

FIG. 1 is a schematic illustration showing an exemplary reaction of an o-naphthoquinone methide (oNQM, generated from an oNQM precursor, NQMP) and a substrate bound thiol. The thioether linkage produced is stable under ambient conditions, but can be cleaved by UV irradiation regenerating free thiol. This feature can allow for the removal or replacement of an immobilized substrate.

FIG. 2 is an exemplary schematic illustration of a reversible surface derivatization using thiol-oNQM photoclick chemistry.

FIG. 3 is an exemplary schematic illustration of immobilization and replacement of NQMP-derivatized substrates.

FIG. 4 illustrates exemplary florescent microscopic images of thiol-derivatized glass slides irradiated via a 12 μm pitch TEM grid from above (A) and from below (B).

FIG. 5 is an exemplary schematic illustration of sequential click derivatizations utilizing a tiol-oNQM click followed by (a) strain-promoted azide-alkyne click (SPAAC) reaction, or (b) biotin-Avidin complexation and the resulting fluorescent microscopic images.

FIG. 6 illustrates exemplary florescent microscopic images demonstrating specific vs. non-specific binding of FITC-Avidin to biotin photo-patterned slides: (A) no PEGylation; (B) post-photolysis treatment with Maleimide-PEG (MW-2000); and (C) NQMP-TEG groups are selectively replaced with NQMP-Biotin.

FIG. 7 illustrates fluorescent images of FITC-Avidin binding to photo-biotinylated slides: (A) flood irradiation with 1b and masked irradiation with 1c; (B) flood irradiation with 1c and masked irradiation with 1b; (C) flood irradiation with 1c, masked irradiation with 1b, followed by flood irradiation with 1c; and (D) fluorescent intensity profiles along the line perpendicular to the pattern in images B (peaks and valleys) and C (line).

FIG. 8 is a schematic illustration showing exemplary methods for preparing an NQMP attached to an aza-dibenzocyclooctyne (NQMP-ADIBO), 1d. Reagents and conditions: (a) 1-ethyl-3-(3-dimethylaminopropyl)carbodiimide) (EDC), 4-dimethylaminopyridine (DMAP), N,N-dimethylformamide (DMF), 80%; and (b) Amberlist-15, acetonitrile, 90%.

### DETAILED DESCRIPTION OF ILLUSTRATIVE EMBODIMENTS

Photochemical surface derivatization can allow for patterned or gradient immobilization of various substrates with high spatial resolution. Light-directed immobilization of carbohydrates (Carroll et al., Glycoconj. J 2008, 25:5), proteins (Blawas et al., Biomaterials 1998, 19:595; Nakajima, Flow Inj. Anal. 2006, 23:123; Popper et al., Arch. Path. & Lab. Med. 2008, 132:1570; Ganesan et al., J. Mater. Chem. 2008, 18:703; and Choi et al., J. Polym. Sci. A 2009, 47:6124), DNA fragments (Ganesan et al., J. Mater. Chem. 2008, 18:703; Choi et al., J. Polym. Sci. A 2009, 47:6124; Morais et al., Chem. Commun. 2006, 2368-70; Afroz et al., Clin. Chem. 2004, 50:1936-9; Choi et al., Anal. Biochem. 2005, 347:60-66; Gao et al., Biopolymers 2004, 73:579-596; and McGlennen, Clin. Chem. 2001, 47:393-402), antibodies (Blawas et al., Biomaterials 1998, 19:595; Nakajima, Flow Inj. Anal. 2006, 23:123; Popper et al., Arch. Path. & Lab. Med. 2008, 132:1570; Crawford et al., Life Sc. Innov. 2008, 103; and Chen et al., Clin. Proteomics 2008, 101), cells, and other substrates (Dillmore et al., Langmuir 2004, 20:7223; Petrou et al., Biosens. Bioelectron. 2007, 22:1994; Kim et al., Angew. Chem. Int. Ed. 2009, 48:3507; Jang et al., Biomaterials 2009, 30:1413; Lee et al., ChemBioChem 2009, 10:1648; and Liu et al., Chin. J. Anal. Chem. 2009, 37:943), can be employed in the development of novel biotech and analytical tools (Panda et al., Trends Cell Biol. 2003, 13:151; MacBeath et al., Science 2000, 289:1760; Delehanty et al., Anal.

Chem. 2002, 74:5681; Chen et al., Biochem. Biophys. Res. Commun. 2003, 307:355; Chiellini et al., Macromol. Rapid. Commum. 2001, 22:1284; and Wu et al., Chem. Commun. 2011, 47:5664). Recently developed surface derivatization techniques combine the efficiency of “click” reactions with high spatial resolution of photolithography. Some of these “photo-click” reactions rely on the photochemical generation of appropriate functional groups on the surface, such as azide-reactive cyclooctynes (Orski et al., J. Am. Chem. Soc. 2010, 132:11024), alkene-reactive nitrile imines (Wang et al., Angew. Chem. Int. Ed. Engl. 2009, 48:5330; and Song et al., Angew. Chem. Int. Ed. Engl. 2008, 47:2832), hydroquinone dienophiles (Panda et al., Trends Cell Biol. 2003, 13:151; MacBeath et al., Science 2000, 289:1760; Delehanty et al., Anal. Chem. 2002, 74:5681; Chen et al., Biochem. Biophys. Res. Commun. 2003, 307:355; Chiellini et al., Macromol. Rapid. Commum. 2001, 22:1284; and Wu et al., Chem. Commun. 2011, 47:5664), or reactive hetero-dienes (Arumugam et al., J. Am. Chem. Soc. 2012, 134:179). Light induced generation of short-lived surface-reactive species can provide an alternative approach to patterning (Ismaili et al., Langmuir 2011, 27:13261; and Arumugam et al., J. Am. Chem. Soc. 2011, 133:15730). Popular UV-initiated thiol-ene (De Forest et al., Nature Materials 2009, 8:659; Fiore et al., J. Org. Chem. 2009, 74:4422; Fiore et al., Org. Biomol. Chem. 2009, 7:3910; Killops et al., J. Am. Chem. Soc. 2008, 130:5062; Campos et al., Macromolecules 2008, 41:7063; and Chan et al., Chem. Commun. 2008, 4959), and thiol-yne (Hensarling et al., J. Am. Chem. Soc. 2009, 131:14673; and Norberg et al., Biosens. Bioelectron. 2012, 34:51) rely on photochemical reactivity of thiol. However, reactions proceeding via reactive radicals, carbenes, nitrenes, etc. often suffer from inadequate selectivity. Photoreduction of Cu (II) to Cu (I) can allow for the spatial control of copper-catalyzed azide click reaction (Adzima et al., Nature Chem. 2011, 3:258). All these photo-immobilization techniques can produce a covalent bond between the surface and the substrate, and these techniques are usually irreversible. In some cases, immobilized substrate can be cleaved from the surface (Arumugam et al., J. Am. Chem. Soc. 2011, 133:15730; and Dhaimasiri et al., Electrophoresis 2009, 30:3289), but typically the surface cannot be re-used for subsequent immobilizations.

On the other hand, light is often used for the reagent-free and spatially controlled release of the substrates. In this approach, substances can be immobilized using conventional (“dark”) chemistry via a photolabile linker, and irradiation can be used to cleave the link between the surface and the substrate (Shin et al., Chem. Commun. 2011, 47:11942; Yamaguchi et al., Angew. Chem. Int. Ed. 2012, 51:128; Nakanishi et al., J. Am. Chem. Soc. 2004, 126:16314; Pasparakis et al., Angew. Chem. Int. Ed. 2011, 50:4142; Agasti et al., J. Am. Chem. Soc. 2009, 131:5728; Cano et al., J. Org. Chem. 2002, 67:129; Flickinger et al., Org. Lett. 2006, 8:2357; Wu et al., Org. Biomol. Chem. 2009, 7:2247; and Yan et al., Bioconjugate Chem. 2004, 15:1030). As in the previous case, typically the surface cannot be re-used.

The present disclosure provides methods for selective and optionally reversible photo-patterning of various substrates on a thiol-coated surface. Thiol-functionalized surfaces are covered with aqueous solution of substrates conjugated to 3-(hydroxymethyl)-2-naphthol (NQMP). Subsequent irradiation via shadow mask results in an efficient conversion of the NQMP into reactive naphthoquinone methide (NQM) species in the exposed areas. The latter react with thiol groups on the surface producing thioether link between a substrate and a surface. Unreacted NQM groups are rapidly hydrated to regenerate NQMP. The orthogonality of oNQM-thiol and azide click chemistry allowed the development of two-step sequential click strategy, which can be useful for the immobilization of light-sensitive compounds. In this procedure thiol-derivatized surface is first patterened with azide- of acetylene-derivatized NQMP and then the substrate is immobilized using popular azide click chemistry. The thioether linkage produced by the reaction of NQM and a thiol is stable under ambient conditions, but can be cleaved by UV irradiation regenerating free thiol. This feature allows for the removal or replacement of immobilized substrate.

### Precursor Compounds

Precursor compounds as disclosed herein can be irradiated to generate o-quinone methides (e.g., o-naphthoquinone methides). Exemplary precursor compounds can have the formula:

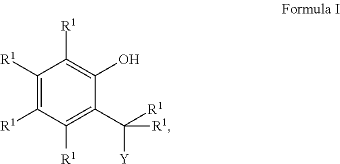

wherein: each R¹ is independently H, halogen, or an organic group; Y is OR⁵, NR⁵₂, NR⁵₃⁺(Z_{1/q})⁻ wherein Z is an anion having a negative charge of q; each R⁵ is independently H or an organic group; optionally, two or more R¹ groups may be combined to form one or more rings; and optionally, two or more R⁵ groups may be combined to form one or more rings. In certain embodiments, the precursor compound has one of the formulas:

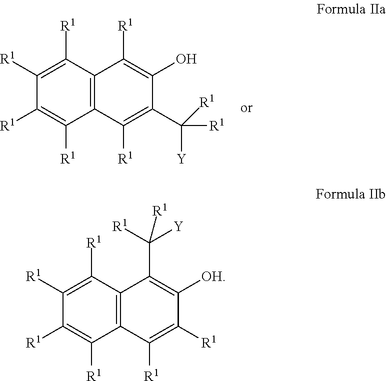

When R¹ and/or R⁵ represent an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety.

As used herein, the term “organic group” is used for the purpose of this disclosure to mean a hydrocarbon group that is classified as an aliphatic group, cyclic group, or combination of aliphatic and cyclic groups (e.g., alkaryl and aralkyl groups). In the context of the present disclosure, suitable organic groups for hetero-Diels-Alder reactants or precursors thereof, as described herein, are those that do not interfere with a light-induced photodehydration reaction and/or the formation of thioethers upon contacting thiols. In the context of the present disclosure, the term “aliphatic group” means a saturated or unsaturated linear or branched hydrocarbon group. This term is used to encompass alkyl, alkenyl, and alkynyl groups, for example. The teen “alkyl group” means a saturated linear or branched monovalent hydrocarbon group including, for example, methyl, ethyl, n-propyl, isopropyl, tert-butyl, amyl, heptyl, and the like. The term “alkenyl group” means an unsaturated, linear or branched monovalent hydrocarbon group with one or more olefinically unsaturated groups (i.e., carbon-carbon double bonds), such as a vinyl group. The term “alkynyl group” means an unsaturated, linear or branched monovalent hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” means a mono- or polynuclear aromatic hydrocarbon group. The term “heterocyclic group” means a closed ring hydrocarbon in which one or more of the atoms in the ring is an element other than carbon (e.g., nitrogen, oxygen, sulfur, etc.).

As a means of simplifying the discussion and the recitation of certain terminology used throughout this application, the terms “group” and “moiety” are used to differentiate between chemical species that allow for substitution or that may be substituted and those that do not so allow for substitution or may not be so substituted. Thus, when the term “group” is used to describe a chemical substituent, the described chemical material includes the unsubstituted group and that group with nonperoxidic O, N, S, Si, or F atoms, for example, in the chain as well as carbonyl groups or other conventional substituents. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, tert-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, tert-butyl, and the like.

In certain embodiments, the precursor compound includes a cyclic alkyne (e.g., a dibenzocyclooctyne such as aza-dibenzocyclooctyne) attached thereto. Such an exemplary precursor compound has the formula

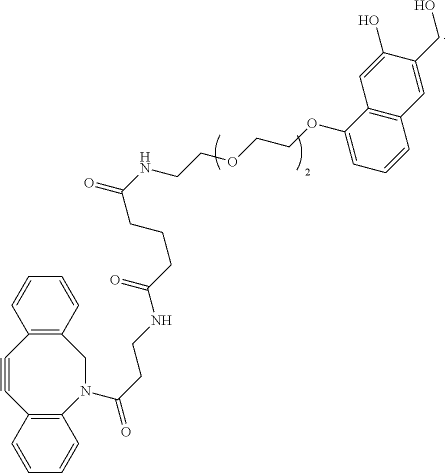

### Irradiation of Precursor Compounds

Typically, the precursor compound is irradiated in an aqueous solution, suspension, or dispersion. As used herein, an aqueous solution, suspension, or dispersion is intended to include liquids that include, but are not limited to, water. Thus, aqueous liquids can also include, for example, organic solvents such as acetonitrile.

Typically, the aqueous solution, suspension, or dispersion of the precursor compound is irradiated at a wavelength of 250 nm to 350 nm Convenient wavelengths include, for example, 350 nm such as those available from a fluorescent UV lamp. Other convenient wavelengths include, for example, 266 nm and 355 nm. Typically, the aqueous solution, suspension, or dispersion of the precursor compound is irradiated under ambient conditions for a time sufficient for the desired reactions to occur. It would be clear to one of skill in the art that suitable irradiation times can be varied depending on a number of factors such as intensity of the irradiation and the area or volume being irradiated. An exemplary suitable time for the irradiation can be 0.5 minutes to 5 minutes.

Conveniently, the precursor compound can be irradiated in the presence of a substrate having a plurality of thiol groups attached thereto, which can react with generated o-quinone methide (e.g., an o-naphthoquinone methide) to form thioethers. For embodiments in which the precursor compound is irradiated in the presence of the substrate having a plurality of thiol groups attached thereto, the substrate can be pattern-wise irradiated to provide a pattern-wise labeled surface of the substrate.

o-Quinone Methides

In another aspect, the present disclosure provides an o-quinone methide having the formula:

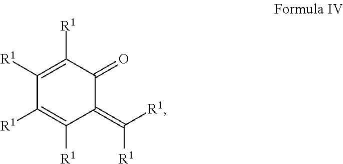

wherein: each R¹ is independently H, halogen, or an organic group; and optionally two or more R¹ groups may be combined to form one or more rings. In certain embodiments, the o-quinone methide is an o-naphthoquinone methide of one of the formulas:

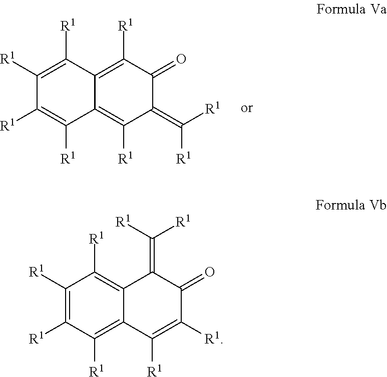

When R¹ represents an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety.

In certain embodiments, the o-quinone methide includes a cyclic alkyne (e.g., a dibenzocyclooctyne such as aza-dibenzocyclooctyne) attached thereto Such an exemplary o-quinone methide can be prepared by the photolysis of a precursor compound having the formula

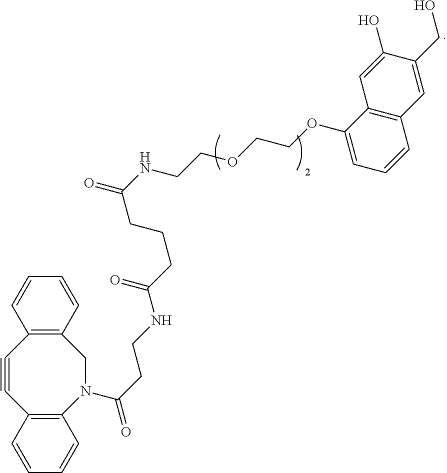

### Methods

In one aspect, the present disclosure provides a method for derivatizing the surface of a substrate. In one embodiment, the method includes: generating an o-quinone methide having the formula:

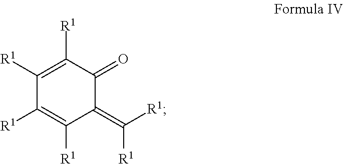

and contacting the o-quinone methide with a substrate having a plurality of thiol groups attached thereto under conditions effective to form a plurality of thioethers (e.g., in an aqueous solution, suspension, or dispersion), wherein: each R¹ is independently H, halogen, or an organic group; and optionally, two or more R¹ groups may be combined to form one or more rings. In certain embodiments, the o-quinone methide is an o-naphthoquinone methide having one of the formulas:

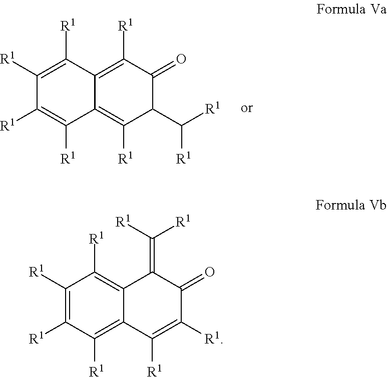

When R¹ represents an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety. In certain embodiments, the substrate includes a planar surface or a bead. In certain embodiments, the substrate can be glass, quartz, silica, a metal, a semi-conductor, a polymer, a membrane, a liposome, a micelle, a macromolecule, a biomaterial (e.g., a virus, a small multicellular organism, DNA, RNA, a peptide, a polypeptide, a protein, a carbohydrate, a lipid, tissue, and combinations thereof), or combinations thereof. As used herein, the term “biomaterial” is meant to include any biological material or material that can be used in a biological method or application. In certain embodiments, the o-quinone methide can include a label that is detectable by method of, for example, fluorescence, phosphorescence, radiation detection, optical methods, electrochemical methods, surface plasmon resonance imaging (SPRi), or combinations thereof. As used herein, a detectable label is meant to include any group or functionality desired that can be detected before and/or after attachment to the surface of a substrate. In certain embodiments, the detectable label can include a probe (e.g., including DNA, a peptide, a polypeptide, a protein, or a combination thereof). Optionally, the method can further include irradiating the derivatized surface of the substrate under conditions effective to reverse at least some of the derivatizaton and provide a substrate having a plurality of thiol groups attached thereto.

In another embodiment, a method for derivatizing the surface of a substrate can include: providing a first precursor compound having the formula:

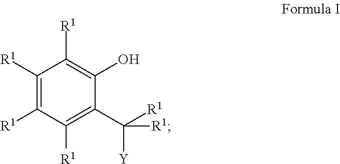

irradiating the first precursor compound under conditions effective to form a first o-quinone methide having the formula:

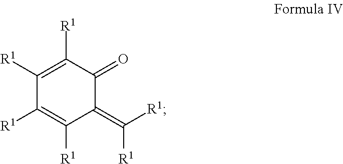

and contacting the first o-quinone methide with a substrate having a plurality of thiol groups attached thereto under conditions effective to form a plurality of thioethers from the reaction of the first o-quinone methide with the plurality of thiols, wherein: each R¹ is independently H, halogen, or an organic group; Y is OR⁵, NR⁵₂, NR⁵₃⁺(Z_{1/q})⁻ wherein Z is an anion having a negative charge of q; each R⁵ is independently H or an organic group, optionally, two or more R¹ groups may be combined to form one or more rings; and optionally, two or more R⁵ groups may be combined to form one or more rings. In certain embodiments, the first precursor compound has one of the formulas:

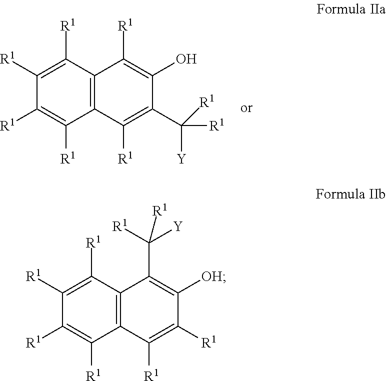

and wherein irradiating the first precursor compound under conditions effective to form the first o-quinone methide forms a first o-naphthoquinone methide having one of the formulas:

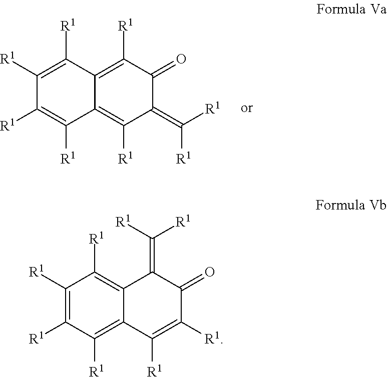

When R¹ and/or R⁵ represent an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C 1-C10 aliphatic group, and in some embodiments a C1-C10 hydrocarbon moiety. In certain embodiments, the first precursor compound is irradiated in the presence of the substrate having the plurality of thiol groups attached thereto. In certain embodiments, irradiating the first precursor compound includes pattern-wise irradiating the substrate to provide a pattern-wise derivatized surface of the substrate. Optionally, the method can further include irradiating the derivatized surface of the substrate under conditions effective to reverse at least some of the derivatizaton and provide a substrate having a plurality of thiol groups attached thereto. In another embodiment, the method can further include contacting the derivatized surface of the substrate with a second precursor compound of Formula I, wherein the second precursor compound is different than the first precursor compound; and irradiating the derivatized surface of the substrate under conditions effective to reverse at least some of the derivatizaton and provide a substrate having a plurality of thiol groups attached thereto; to form a second o-quinone methide of Formula IV that is different than the first o-quinone methide of Formula IV; and to form a plurality of thioethers from the reaction of the second o-quinone methide with the plurality of thiols.

The methods recited in the present disclosure can allow for the development of reagentless and catalyst-free ligation methods. In some embodiments, these methods are based on the in situ photochemical generation of the reactive component of a nucleophilic reaction. This approach can also expand the utility of “click” techniques by permitting temporal and spatial (potentially even 3-D) control over the process. Photogenerated click-substrates are expected to cover a broad range of reactivities from 0.1 to 10⁴ M⁻¹s⁻¹. The advantages of photo-triggered click approaches to ligation and immobilization are well recognized.

Photochemical immobilization of carbohydrates, proteins, DNA fragments, antibodies, and other substrates allows for the formation of patterned or gradient arrays on various surfaces. These techniques can be used in the development of novel high throughput analytical methods.

The photo-triggered click reactions disclosed herein can expand the utility of this technique. The photoreactions employed can produce reactive components that have higher quantum and quantitative chemical yields. As a result, methods described herein typically require only short irradiation with a low intensity lamp, thus exhibiting much less light-induced toxicity in cells, and are very fast and allow for high spatial resolution of labeling or ligation. In addition, they provide a ligation method orthogonal to the azide click reaction. The o-quinone methides do react with water, but this reaction can actually be beneficial, because it regenerates the precursor compound. Thus, photo-ligation methods disclosed herein can be compatible with biological media.

### Derivitized Surface

In certain embodiments, the present disclosure provides a substrate having a derivatized surface including a compound having the formula:

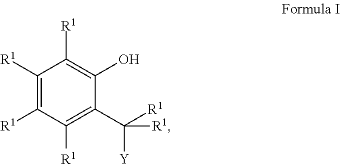

wherein: each R¹ is independently H, halogen, or an organic group; optionally, two or more R¹ groups may be combined to form one or more rings; and Y is a sulfur atom attached to the surface of the substrate. In certain embodiments the substrate has one of the formulas:

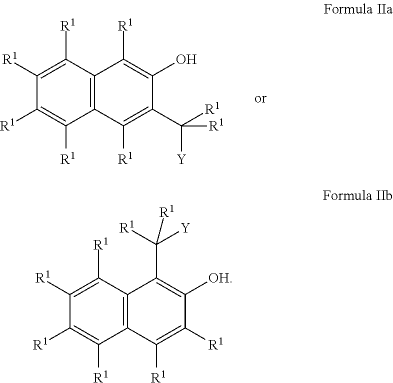

When R¹ represents an organic group, preferably the organic group is a carbon-bound (i.e., the bond to the group is to a carbon atom of the organic group) organic group. In certain embodiments, the organic group is an aliphatic group such as a C1-C20 aliphatic group, in some embodiments a C1-C10 aliphatic group, and in some embodiments a C1-C10 hydrocarbon moiety.

In summary, a very facile reaction between photochemically generated o-naphthoquinone methides (oNQM) and thiols (k is approximately 2×10⁵M⁻¹ seconds⁻¹) was employed for the reversible light-directed surface derivatization and patterning. Thiol-functionalized glass slides were covered with aqueous solution of substrates conjugated to 3-(hydroxymethyl)-2-naphthol (NQMP). Subsequent irradiation via shadow mask resulted in an efficient conversion of the NQMP into reactive oNQM species in the exposed areas. The latter can react with thiol groups on the surface producing a thioether link between a substrate and a surface. Unreacted oNQM groups are rapidly hydrated to regenerate NQMP. The short lifetime (τ is approximately 7 milliseconds in H₂O) of oNQM in aqueous solution prevents its migration from the site of irradiation, thus allowing for the spatial control of surface derivatization. Two-step procedure was employed for protein patterning: photo-biotinylation of the surface with NQMP-biotin conjugate was followed by staining with FITC-avidin. The orthogonality of oNQM-thiol and azide click chemistry allowed the development of sequential click strategy, which can be useful for the immobilization of light-sensitive compounds. The thioether linkage produced by the reaction of oNQM and a thiol is stable under ambient conditions, but can be cleaved by UV irradiation regenerating free thiol; and this feature can allow for the removal or replacement of an immobilized substrate (FIG. 1).

The following examples are offered to further illustrate various specific embodiments and techniques of the present disclosure. It should be understood, however, that many variations and modifications understood by those of ordinary skill in the art may be made while remaining within the scope of the present disclosure. Therefore, the scope of the disclosure is not intended to be limited by the following examples.

### EXAMPLES

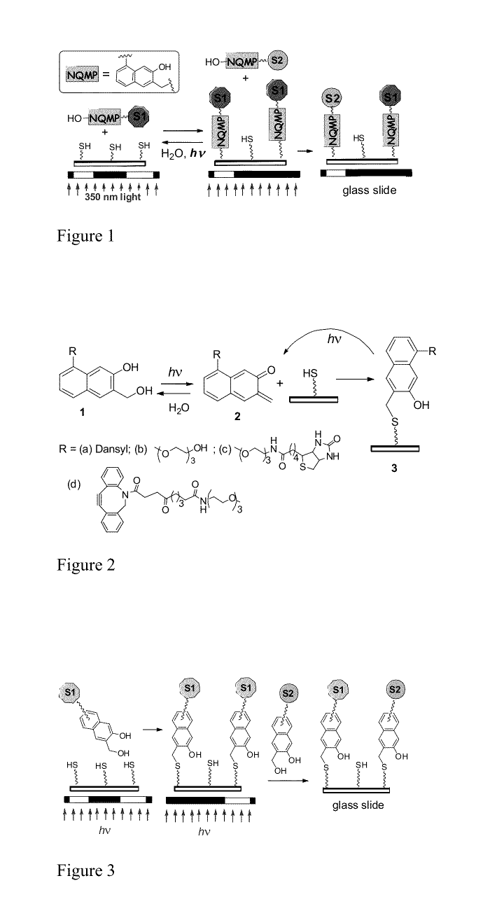

A new surface photo-derivatization strategy that not only allows for the patterned immobilization of various substrates on the surface, but also allows for light-directed release or replacement of the immobilized substances, is disclosed herein. This method is based on a very facile reaction between 2-napthoquinone-3-methides (oNQMs, 2) and thiols to produce thioether (FIG. 2). A thiol-derivatized surface was immersed in an aqueous solution of a substrate conjugated to 3-(hydroxymethyl)-2-naphthol (NaphthoQuinone Methide Precursors, NQMP 1) and irradiated via shadow mask (FIG. 2). The NQMP moiety can undergo efficient photochemical dehydration (Φ=0.20) to produce oNQM (2) (Arumugam et al., J. Am. Chem. Soc. 2009, 131:11892). In the presence of surface thiols, oNQMs can undergo very rapid (k_{RSH} is approximately 2.2×10⁵ M⁻¹ seconds⁻¹) Michael addition to yield thioether 3 (FIG. 2), and the unreacted oNQMs can be hydrated (k_{H2O} is approximately 145 seconds⁻¹) to regenerate NQMP (1) (Arumugam et al., J. Am. Chem. Soc. 2009, 131:11892). A very short lifetime of oNQM (τ_{H2O} is approximately 7 milliseconds) species in aqueous solutions can prevent their migration from the site of irradiation, allowing for a high spatial resolution of derivatization (vide infra). Due to much higher nucleophilicity of thiols, their quantitative conversion in the exposed areas can be achieved despite a large excess of nucleophilic solvent.

The thioether (3) produced in the reaction of thiols with oNQM is hydrolytically stable but can be quantitatively cleaved under 300 or 350 nanometer irradiation back to 2 with 10% quantum yield (Arumugam et al., J. Am. Chem. Soc. 2011, 133:5573). Thus, subsequent irradiation of photo-derivatized surface 3 in an aqueous solution containing no NQMP reagents can result in photo-hydrolysis of the thioether and the release of the substrate (FIG. 2). This process can also regenerate free thiols on the surface. In essence, the formation of 3 is a photochemically driven equilibrium between thiol and NQMP 1 on one side, and thioether 3 and water on the other side. Since oNQM 2 reacts about five orders of magnitude faster with thiols (k_{RSH} is approximately 2.2×10⁵ M⁻¹ seconds⁻¹) than with water (k_{H2O} is approximately 2.6 M⁻¹ seconds⁻¹), and thioethers 3 are 50% less prone to photoelimination than NQMP 1, equilibrium is shifted towards the formation 3. However, if no NQMP is present in the solution, irradiation of 3 can result in a complete photo-hydrolysis. If a different NQMP-tagged substrate is present in solution, a quantitative substitution (substrate 1->substrate 2, FIG. 3) can take place in the exposed areas.

To demonstrate the efficiency of this photo-click strategy, substrates 1 a-d were patterned on commercially available thiol-derivatized microscopic glass slides. A TEM grid (12 μM pitch) was employed as a shadow for patterned irradiation of the slides. Conjugation of NQMP to the substrate of interest was achieved in a few simple steps (e.g., 1a-d) and resulting NQMP-derivatized compounds were stable under ambient conditions, and they required no special handling.

Photo Patterning of Dansyl Fluorophore.

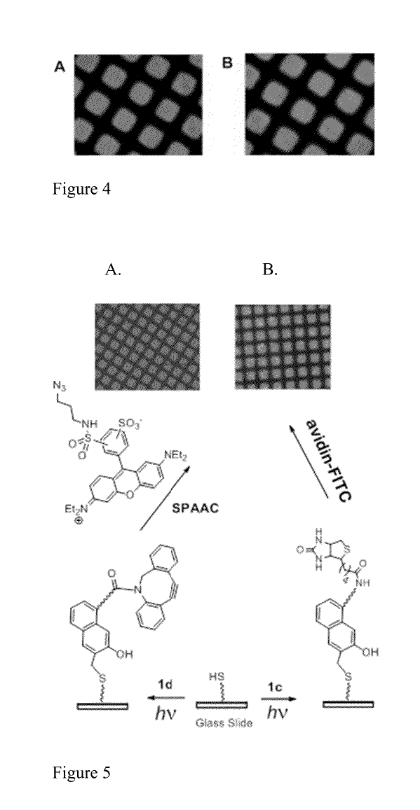

Two procedures were employed for dansyl derivatization of thiol-coated glass slides. In method A, slides were immersed in a 0.2 mM solution of (5-dansyloxy-3-hydroxynaphthalen-2-yl)methanol (DNS-NQMP, 1a), irradiated via a TEM grid using a hand held fluorescent UV lamp (4W 350 nanometer) for 4 minutes (FIG. 4A). Alternatively (method B), slides were covered with a thin layer the same DNS-NQMP solution and irradiated from below (FIG. 4B). Patterned slides were rinsed with water, methanol, and blow-dried under a stream of nitrogen. Images were obtained using a fluorescent microscope.

Both methods produced similar, if not identical, brightness and resolution of the Dansyl fluorescent dye pattern. This experiment demonstrated that patterning of the dye was achieved by selective light exposure, and not by squeezing out the reagent when the mask was placed on a slide. The second procedure was more convenient because the mask was not immersed in the reagent solution. The second procedure was employed for all subsequent experiments.

Next, two identical slides were irradiated for 4 minutes in 0.2 mM and 0.4 mM solution of NQMP 1a. Average fluorescence intensities of both slides were identical within the experimental uncertainty. This experiment shows that 0.2 mM of NQMP and 4 minutes of irradiation is enough for functionalization of all available thiol groups.

A quinone methide-thiol click reaction is orthogonal to the majority of other derivatization techniques, including well-developed alkyne-azide click chemistry. Concurrent or sequential applications of photo-click and alkyne-azide click ligations can allow for one-pot derivatization of substrates with multiple moieties, and/or for the light-directed patterning of photosensitive groups. To demonstrate the efficiency of such sequential click immobilization, a heterobifunctinal click reagent, NQMP-ADIBO (1d), that contains both a photoreactive NQMP group and a strained alkyne (aza-dibenzocyclooctyne) was employed (Kuzmin et al., Bioconj. Chem. 2010, 21, 2076). The latter moiety permits efficient conjugation with azide-tagged substances via a strain-promoted azide-alkyne click reaction (SPAAC). The resulting NQMP-cyclooctyne conjugate was photo-patterned onto a thiol-coated surface, washed, and immersed in a 0.1 mM DMF solution of Rhodamine B azide for 1 hour. The fluorescent microscopic image of the resulting slide is shown in FIG. 5a. This image shows that a sequential click strategy can allow for clean and selective immobilization of azide-tagged substrates.

oNQM-Thiol click chemistry was also found to be suitable for protein immobilization. Thus, FITC-avidin was photo-patterned on a thiol-coated glass slide using a two-step procedure. First, NQMP-biotin conjugate (lc) was micro-patterned on the slide using a thiol photo-click reaction (FIG. 5b). The resulting biotinylated slide was immersed into a solution of FITC-Avidin (50 μL of 2 mg/mL in 10 mL PBS) at 2° C. for 15 minutes. The non-specifically bound FITC-Avidin was removed by sonicating the glass slides in PBS solution for 30 minutes followed by overnight incubation in fresh phosphate buffer. The fluorescence microscopic images demonstrate that Avidin was immobilized only in the exposed areas (FIG. 5b).

Protein patterning procedures often require extensive washing to remove substrate non-specifically absorbed on the surface. In our experiments, washing for at least 16 hours was used to bring the signal to noise ratio into the 70:1 range. From a practical point of view, a shorter washing procedure could enhance the efficiency of photo-click protein patterning. In order to reduce non-specific protein binding, two PEGylation procedures were tested.

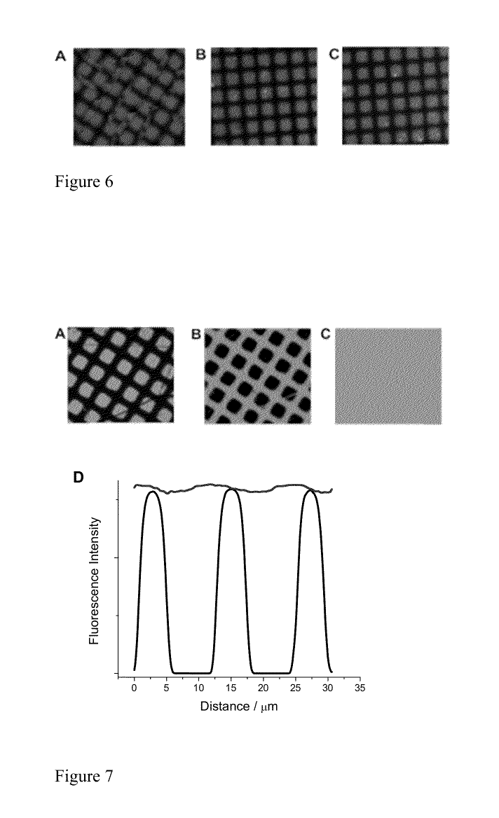

A control FITC-Avidin patterned slide (FIG. 6A), prepared as described above, and two PEGylated slides were rinsed with water and incubated in fresh PBS solution for 1 hour after FITC-Avidin treatment.

In a first PEGylation method, thiol-derivatized glass slides were patterned with NQMP-biotin (1c), rinsed, and treated with the maleimede-PEG2000 conjugate to block all of the remaining thiol groups on the surface. The resulting fluorescent image of this slide shows high contrast between biotinilated and biotin-free areas (FIG. 6B).

In a second PEGylation method, a unique feature of oNQM-thiol click chemistry, i.e., reversibility, was employed. First, a thiol-derivatized slide was flood irradiated in a 0.2 mM aqueous solution of NQMP-TEG conjugate (1b). This procedure covers the surface with highly hydrophilic NQMP-TEG moieties and significantly reduces protein binding (Arumugam et al., J. Am. Chem. Soc. 2011, 133:15730). The resulting TEGylated slide was then immersed into 0.2 mM solution of NQMP-biotin conjugate 1c and irradiated via a TEM grid. The microscopic fluorescent image of the slide clearly demonstrated that NQMP-TEG groups (1d) were replaced with NQMP-Biotin (1c, FIG. 6C). While 1 hour washing was clearly insufficient to obtain good contrast in FITC-Avidin patterning, both post-photolysis PEGylation and photochemical NQMP-TEG replacement procedures can produce a protein pattern with high contrast and resolution.

To further demonstrate the reversibility of the thiol-oNQM chemistry, a thiol-derivatized surface was exhaustively photo-TEGylated in NQMP-TEG 1b solution. The biotin pattern was introduced by irradiating the slide in NQMP-Biotin 1c through a shadow mask. FITC-Avidin treatment produced a high resolution protein pattern shown in FIG. 7A. The high contrast of the image indicated the efficient replacement of 1b with 1c in the exposed areas (FIG. 7D). In complete reversal of the process, flood irradiation of the thiol-derivatized glass slide in NQMP-Biotin (1c) solution followed by NQMP-TEG (1b) photo-patterning produced a negative image (FIG. 7B). The resulting slide was then flood irradiated in NQMP-Biotin (1c) solution and stained with FTC-Avidin (FIG. 7C). The uniform fluorescence of the resulting slide illustrated the complete reversibility of the oNQM-thiol click immobilization procedure.

The fluorescent intensity profile of image B (FIG. 7D) showed that oNQM-thiol photoclick patterning technique readily reproduced features as small as 5 μm. This is a remarkable result, because the photoreactive compound was not immobilized on the surface, but rather was present in a low viscosity solution. The short lifetime (τ is approximately 7 milliseconds) of oNQM in aqueous solution prevented migration of reactive species from the site of irradiation. The intensity profile of image C (FIG. 7D) revealed that there is no appreciable change in the fluorescence intensity between the original and the regenerated image. This observation underscored the efficiency of the reversible immobilization and indicated that the surface density of thiol groups was not significantly affected by the multiple formations and photo-hydrolyses of the thioether.

In summary, an efficient photo-click immobilization strategy based on the very fast reaction of photochemically generated o-naphthoquinone methides (oNQMs) with thiol on a glass surface has been disclosed. Since thiol-derivatized surfaces are readily available and a wide variety of substrates can be derivatized with naphthoquinone methide precursor group, 3-(hydroxymethyl)-2-naphthols (NQMP), this method can offer a new platform for light-directed surface functionalization. An oNQM-thiol click photo-patterning approach is orthogonal to other derivatization techniques, and it can be used in conjunction with well-developed acetylene-azide click chemistry. A solution of NQMP-conjugated substrate can be re-used numerous times without loss of efficiency, because a very minute amount of the reagent is consumed for the derivatization of the substrate, and all unreacted oNQMs is quenched with water to regenerate NQMP. The short lifetime of photo-generated reactive species (oNQM) limits their migration from the site of irradiation and permits a high spatial resolution of the patterning process. A unique feature of the oNQM-thiol photo-click chemistry is the reversibility of the process, which allows for the release of immobilized substrates from a surface, or for the replacement of one substrate with another. This feature can be used in the development of light-healable surface coatings, time-resolved photo-release of bioactive molecules, and renewable and repairable microarray technologies. The high stability and robustness of NQMP group and the compatibility of oNQM-thiol chemistry with aqueous solutions makes photo-click immobilization suitable for biological applications.

### Experimental Procedures

General Information.

All organic solvents were dried and freshly distilled before use. Flash chromatography was performed using 40-63 μm silica gel. All NMR spectra were recorded on 400 MHz instruments in CDCl₃ and referenced to TMS unless otherwise noted. Solutions were prepared using HPLC grade water and acetonitrile.

Materials:

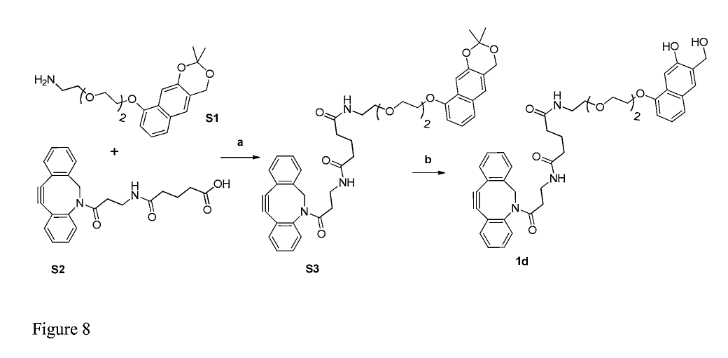

Thiol functionalized microscope glass slides were purchased from Xenopore Corp. Methoxy PEG Maleimide (MW 2000) was purchased from JenKem Technology USA Inc. FTIC-Avidin and Rhodamine B were purchased from Life Technologies. All other chemicals were purchased from Sigma-Aldrich and were used as received. 8-TEG-3-(hydroxymethyl) naphthalen-2-ol (NQMP-TEG, 1b) (Arumugam et al., J. Chem. Soc. 2011, 133:15730), 9-(Amino-TEG)-2,2-dimethyl-4H-naphtho[2,3-d][1,3]dioxine (S1) (Arumugam et al., J. Am. Chem. Soc. 2011, 133:15730), 8-(Biotin-TEG)-3-(hydroxymethyl)naphthalen-2-ol (NQMP-Biotin, 1c) (Arumugam et al., J. Am. Chem. Soc. 2011, 133:15730), ADIBO-carboxylic acid (S2) (Cheng et al., Bioconjugate Chem. 2011, 22:2021), 5-dansyloxy-3-hydroxynaphthalen-2-yl)methyl (DNS-NQMP, 1a) (Arumugam et al., Photochem. Photobiol. Sci. 2012, 11:518) and azido Rhodamine B (Orski et al., J. Am. Chem. Soc. 2010, 132:11024) were prepared following previously reported procedures. S3 and 1d were prepared as shown in FIG. 8, as further discussed herein below.

Protected NQMP-TEG-ADIBO (S3):

1-Ethyl-3-(3-dimethylaminopropyl) carbodiimide hydro-chloride (97 mg, 0.3 mmol) and catalytic amount of DMAP were added to a solution of ADIBO-carboxylic acid S2 (150 mg, 0.38 mmol) in 8 mL of dry DMF, followed by a dropwise addition of a solution of amine S1 (151 mg, 0.42 mmol) in 2 mL of DMF. The mixture was stirred for 12 hours at room temperature, solvent was removed in vacuum, the residue was dissolved in DCM, washed with NaHCO₃ solution, brine, dried over anhydrous magnesium sulfate, and the concentrated under reduced pressure. The residue was purified by column chromatography using (10% MeOH in dichloromethane) to yield 225 mg (80%) of the ketal S3. ¹H NMR: 7.55 (d, J=7.9 Hz, 2H), 7.36-7.03 (m, 10H), 6.61 (d, J=7.5 Hz, 1H), 6.48 (t, J=5.6 Hz, 1H), 6.36 (t, J=6.0 Hz, 1H), 5.02 (d, J=14 Hz, 1H), 4.95 (m, 2H), 4.14 (t, J=4.8 Hz, 2H), 3.84 (dd, J=5.6, 3.9 Hz, 2H), 3.70-3.64 (m, 2H), 3.60-3.53 (m, 3H), 3.52-3.43 (m, 2H), 3.40-3.05 (m, 4H), 2.44-2.29 (m, 2H), 2.04-1.62 (m, 6H), 1.50 (s, 6H). ¹³C NMR: 172.7, 172.6, 172.5, 153.7, 151.2, 149.7, 148.2, 132.3, 129.7, 129.2, 128.8, 128.6, 128.4, 128.1, 127.4, 126.3, 125.8, 123.9, 123.4, 123.2, 122.7, 121.8, 120.2, 115.0, 107.9, 107.2, 104.9, 100.0, 71.0, 70.4, 70.0, 69.9, 68.0, 61.3, 55.8, 53.7, 39.4, 35.6, 35.3, 35.2, 34.6, 25.2, 25.2, 22.1. FW calc [(C₄₃H₄₈N₃O₈)H⁺: 734.344; EI-HRMS: 734.3434.

NQMP-ADIBO (1d):

About 75 mg of Amberlyst-15 resin was added to a solution of ketal S3 (200 mg, 0.17 mmol) in 5 mL of acetonitrile and stirred for 2 hours at room temperature. 10 mL of DCM was added to a reaction mixture, the resin was removed by filtration through a cotton plug, and the acetonitrile/DCM solution was passed through short silica gel column to yield 170 mg analytically pure ADIBO-NQMP (1d) in 90% yield. ¹H NMR: 7.77 (d, J=7.9 Hz, 2H), 7.56-7.23 (m, 10H), 6.82 (d, J=7.5 Hz, 1H), 6.68 (t, J=5.6 Hz, 1H), 6.55 (t, J=6.0 Hz, 1H), 5.21 (d, J=14 Hz, 1H), 5.15 (m, 2H), 4.33 (t, J=4.8 Hz, 2H), 4.05 (dd, J=5.6, 3.9 Hz, 2H), 3.90-3.83 (m, 2H), 3.80-3.72 (m, 3H), 3.71-3.63 (m, 2H), 3.60-3.25 (m, 4H), 2.64-2.48 (m, 2H), 2.24-1.82 (m, 6H). ¹³C NMR: 170.8, 170.5, 170.5, 151.7, 149.2, 147.6, 146.2, 130.3, 127.7, 127.2, 126.8, 126.6, 130.4, 126.1, 125.4, 124.3, 123.8, 121.9, 121.4, 121.2, 120.7, 119.8, 119.2, 105.9, 105.1, 102.9, 98.1, 69.0, 68.4, 68.0, 67.9, 66.0, 59.3, 53.8, 51.7, 37.4, 33.6, 33.3, 33.2, 32.6, 20.1. FW calc [(C₄₀H₄₃N₃O₈)H⁺):694.3128; EI-HRMS: 694.3120.

### Methods: Photochemical Derivatization of Thiol-Functionalized Glass Slides

Uniform Derivatization:

Slides were immersed in 0.2 mM aqueous solution of NQMP precursor 1a-d and irradiated for 2 minutes using mini-Rayonet photochemical reactor equipped with 8 fluorescent UV lamps (4W, 350 nanometer).

Patterned Derivatization Method A.

A 1×1 inch thiol derivatized glass slide was placed on a elastic support and covered with a thin layer of an aqueous solution of 1a-d (0.2 mM), a TEM grid mask was gently placed over the solution and a cover glass plate (quartz) was placed over the mask to keep it fixed in position. When placing the cover plate, care should be taken not to squeeze out the reaction solution. Irradiation was carried out through the cover glass using a hand held UV fluorescent lamp (4 W, 350 nanometer) for 4 minutes.

Patterned Derivatization Method B.

A TEM grid was affixed to the backside (non-derivatized) of the glass slide using screw clamps. This set-up was placed over 4 W UV lamp with the thiol functionalized slide facing upwards. A thin layer of an aqueous solution of NQMP precursor 1a-d (0.2 mM) was placed over the thiol surface and the irradiation was carried out from the bottom of the glass slide.

Patterned Immobilization of FTIC-Avidin:

NQMP-Biotin conjugate 1c was micro-patterned on a thiol functionalized glass slide following the procedure “B”. The latent image was developed using Fluorescein labeled avidin following the previously reported procedure (Carroll et al., Glycoconj. 0.1 2008, 25:5).

Double Click Derivatization:

NQMP-TEG-ADIBO (1d) was micro-patterned on a thiol functionalized glass slide following the procedure “B”. The patterned surfaces were then incubated in a 1 mM solution of azido Rhodamine B (1 mM) for 1 hour, and washed with DMF and methanol.

Images of the patterned slides were obtained using an Olympus IX71 inverted fluorescence microscope.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A method for derivatizing the surface of a substrate, the method comprising:
generating an o-quinone methide having the foiinula: 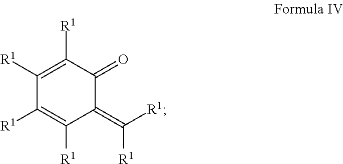
and
contacting the o-quinone methide with a substrate having a plurality of thiol groups attached thereto under conditions effective to form a plurality of thioethers, wherein:
each R¹ is independently H, halogen, or an organic group; and
optionally, two or more R¹ groups may be combined to form one or more rings.

2. The method of claim 1 wherein the o-quinone methide is an o-naphthoquinone methide having one of the formulas:

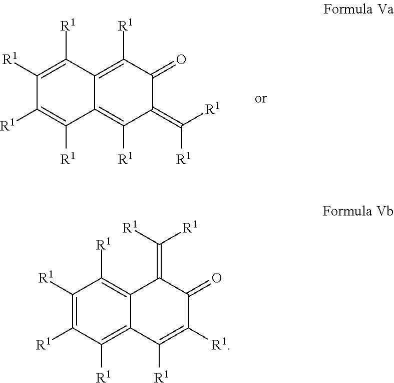

3. The method of claim 1 wherein the substrate comprises a planar surface or a bead.

4. The method of claim 1 wherein the substrate is selected from the group consisting of glass, quartz, silica, a metal, a semi-conductor, a polymer, a membrane, a liposome, a micelle, a macromolecule, a biomaterial, and combinations thereof.

5. The method of claim 4 wherein the biomaterial is selected from the group consisting of a virus, a small multicellular organism, DNA, RNA, a peptide, a polypeptide, a protein, a carbohydrate, a lipid, tissue, and combinations thereof.

6. The method of claim 1 wherein the o-quinone methide comprises a label that is detectable by a method selected from the group consisting of fluorescence, phosphorescence, radiation detection, optical methods, electrochemical methods, surface plasmon resonance imaging (SPRi), and combinations thereof.

7. The method of claim 1 wherein the o-quinone methide comprises a detectable label comprising a probe.

8. The method of claim 7 wherein the probe comprises DNA, a peptide, a polypeptide, a protein, or a combination thereof.

9. The method of claim 1 wherein conditions effective comprise contacting in an aqueous solution, suspension, or dispersion.

10. The method of claim 1 further comprising irradiating the derivatized surface of the substrate under conditions effective to reverse at least some of the derivatizaton and provide a substrate having a plurality of thiol groups attached thereto.

11. A method for derivatizing the surface of a substrate, the method comprising:
providing a first precursor compound having the formula: 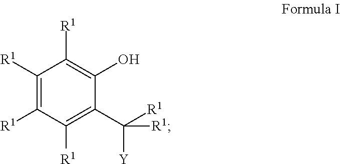
irradiating the first precursor compound under conditions effective to form a first o-quinone methide having the formula: 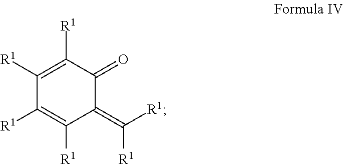
and
contacting the first o-quinone methide with a substrate having a plurality of thiol groups attached thereto under conditions effective to form a plurality of thioethers from the reaction of the first o-quinone methide with the plurality of thiols,
wherein:
each R¹ is independently H, halogen, or an organic group;
Y is OR⁵, NR⁵₂, NR⁵₃⁺(Z_{1/q})⁻ wherein Z is an anion having a negative charge of q; each R⁵ is independently H or an organic group;
optionally, two or more R¹ groups may be combined to form one or more rings; and
optionally, two or more R⁵ groups may be combined to form one or more rings.

12. The method of claim 11 wherein the first precursor compound has one of the formulas: 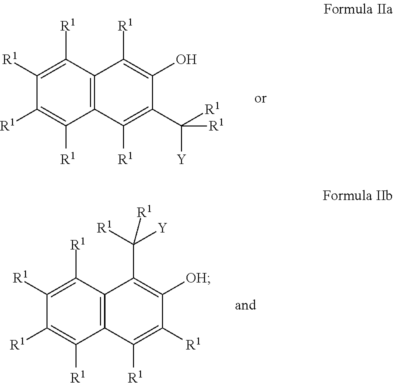
wherein irradiating the first precursor compound under conditions effective to form the first o-quinone methide forms a first o-naphthoquinone methide having one of the formulas:

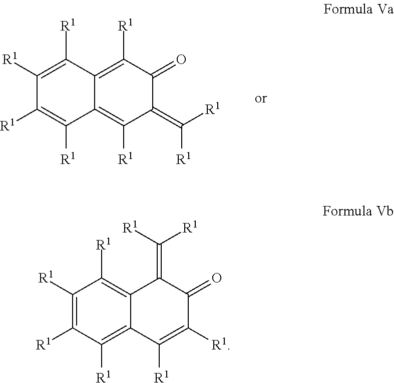

13. The method of claim 11 wherein the first precursor compound is irradiated in the presence of the substrate having the plurality of thiol groups attached thereto.

14. The method of claim 11 wherein irradiating the first precursor compound comprises pattern-wise irradiating the substrate to provide a pattern-wise derivatized surface of the substrate.

15. The method of claim 11 further comprising irradiating the derivatized surface of the substrate under conditions effective to reverse at least some of the derivatizaton and provide a substrate having a plurality of thiol groups attached thereto.

16. The method of claim 11 further comprising:
contacting the derivatized surface of the substrate with a second precursor compound of Formula I, wherein the second precursor compound is different than the first precursor compound; and
irradiating the derivatized surface of the substrate under conditions effective to reverse at least some of the derivatization and provide a substrate having a plurality of thiol groups attached thereto, to form a second o-quinone methide of Formula IV that is different than the first o-quinone methide of Formula IV, and to form a plurality of thioethers from the reaction of the second o-quinone methide with the plurality of thiols.

17. A substrate having a derivatized surface comprising a compound having the formula: 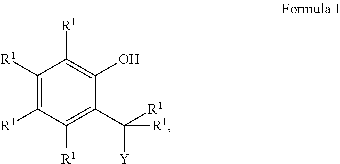
wherein:
each R¹ is independently H, halogen, or an organic group;
optionally, two or more R¹ groups may be combined to form one or more rings; and
Y is a sulfur atom attached to the surface of the substrate.

18. The substrate of claim 17 wherein the compound has one of the formulas:

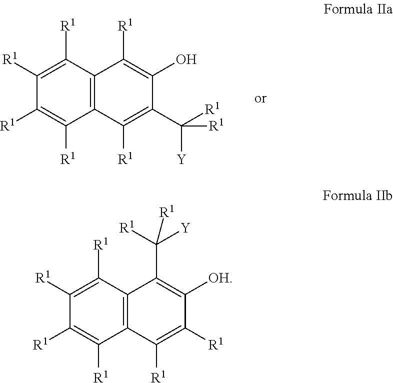

19. A precursor compound having the formula: 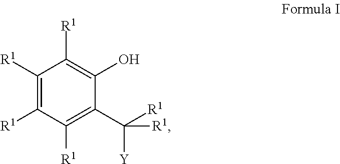
wherein:
each R¹ is independently H, halogen, or an organic group;
Y is OR⁵, NR⁵₂, NR⁵₃⁺(Z_{1/q})⁻ wherein Z is an anion having a negative charge of q;
each R⁵ is independently H or an organic group;
optionally, two or more R¹ groups may be combined to form one or more rings; optionally, two or more R⁵ groups may be combined to form one or more rings; and
with the proviso that the precursor compound comprises a cyclic alkyne attached thereto.

20. The precursor compound of claim 19, wherein the precursor compound has one of the formulas:

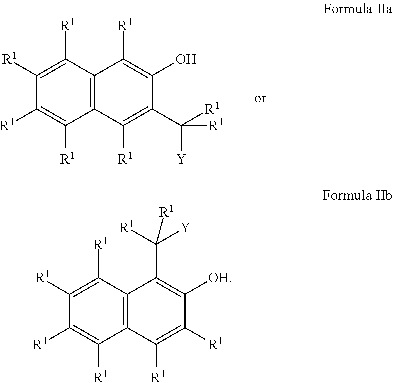

21. The o-quinone methide of claim 19 wherein the cyclic alkyne attached thereto is a dibenzocyclooctyne.

22. The o-quinone methide of claim 21 wherein the dibenzocyclooctyne is an aza-dibenzocyclooctyne.

23. The precursor compound of claim 22 wherein the precursor compound has the formula

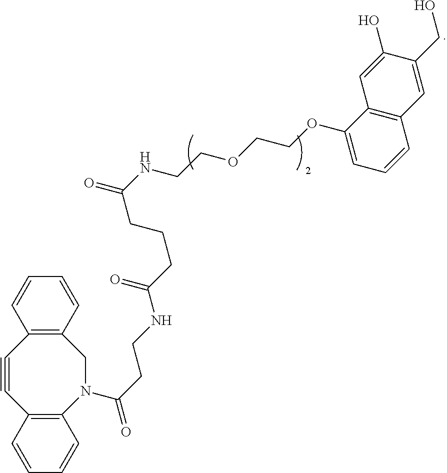

24. An o-quinone methide having the formula: 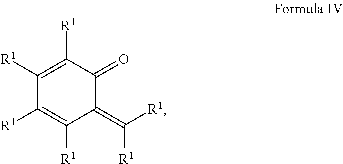
wherein:
each R¹ is independently H, halogen, or an organic group;
optionally two or more R¹ groups may be combined to form one or more rings; and
with the proviso that the o-quinone methide comprises a cyclic alkyne attached thereto.

25. The o-quinone methide of claim 24 wherein the o-quinone methide is an o-naphthoquinone methide of one of the formulas:

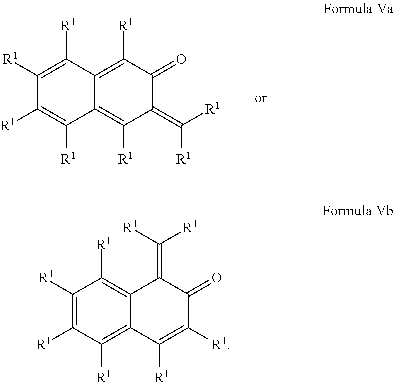

26. The o-quinone methide of claim 24 wherein the cyclic alkyne attached thereto is a dibenzocyclooctyne.

27. The o-quinone methide of claim 26 wherein the dibenzocyclooctyne is an aza-dibenzocyclooctyne.

28. The o-quinone methide of claim 27 prepared by the photolysis of a precursor compound having the formula [chemical structure]
